(19) United States
(12) Patent Application Publication
(10) Pub. No.: US 2012/0308967 A1
(43) Pub. Date: Dec. 6, 2012

(54) Method for Displaying Wildfires and History

(76) Inventors: Shea Armand Broussard, Malibu, CA (US); Anthony David Shafer, Malibu, CA (US)

(21) Appl. No.: 13/485,625

(22) Filed: May 31, 2012

Related U.S. Application Data
(60) Provisional application No. 61/492,208, filed on Jun. 1, 2011.

(51) Int. Cl. G09B 29/00

(52) U.S. Cl. 434/151

(57) ABSTRACT

A method and system for displaying predicted wildfire movements and wildfire history including getting fire history data, analyzing the fire history data to find significant wildfire parameters, determining wildfire modeling parameters, modeling the wildfire behavior to create a plurality of preconfigured models, processing geographical data for each of the preconfigured models, overlaying the geographic data onto the map data for each of the preconfigured models and selectively displaying the overlaid geographic data onto the map data and/or history data via a display.

### BACKGROUND OF THE INVENTION

1. Field of Invention

A method for displaying wildfires movement and history to nontechnical users which is easy to use to view, interpret and understand the data required to predict wildfire movements and paths and view history data using an internet or cloud environment based methodology.

2. Prior Art

In the prior art there are numerous existing wildfire simulation modeling programs which are utilized by the experts in wildfire prediction. These wildfire simulation modeling programs include Flamemap, Farsight, Behaveplus, Flamelet, Firefamilyplus and Wind Ninja. While these various prior art wildfire simulation modeling programs can be used to track wildfires effectively, applying and utilizing these wildfire modeling programs is difficult due to their complex user interfaces, their limited interface compatibility, and their inability to interpret the data provided to them swiftly. In addition, it may take years to learn to proficiently use the prior art wildfire simulation modeling programs.

### SUMMARY OF THE INVENTION

Accordingly, it is an object of the present invention to provide a method and means for nontechnical users who are not experts in the utilization of sophisticated wildfire simulation modeling programs to be able to easily view, interpret and understand the time-varying, complex, spatial data which represents the history, movement, track and/or path of wildfires.

It is another object of the present invention to provide a method for displaying predicted wildfire movements which does so quickly, efficiently and easily.

It is still another object of the present invention to provide a method for displaying predicted wildfire movements which can be provided in a portable device as small as a smartphone.

In keeping with the principles of the present invention, the object can be accomplished by a method for displaying predicted wildfire movements including the steps of getting wildfire history data for a predetermined fire area, analyzing the wildfire history data to find the significant parameters of the wildfires in the predetermined fire area, determining wildfire modeling parameters utilizing the significant parameters, modeling wildfire behavior based upon the wildfire modeling parameters to create preconfigured models of the predetermined fire area, creating geographical data for each of the preconfigured models, getting map data for the predetermined fire area, overlaying the geographical data onto the map data for the predetermined fire area for each of the predetermined models and selectively displaying overlaid geographical data on the map data and wildfire history data onto a display.

### BRIEF DESCRIPTION OF THE DRAWINGS

The above mentioned features and objects of the present invention will become more apparent with reference to the following description taken in conjunction with the accompanying drawings wherein like reference numerals denote like elements and in which:

FIG. 1 is a flow diagram of the general method of the present invention;

FIG. 2 is a block diagram of the present invention;

FIG. 3 is a block diagram of a portion of FIG. 2; and

FIG. 4 is a block diagram of a portion of FIG. 1.

### INCORPORATION BY REFERENCE

The entire contents of provisional application No. 61/492,208 filed on Jun. 1, 2011 is incorporated by reference as if herein stated.

### DETAILED DESCRIPTION OF THE INVENTION

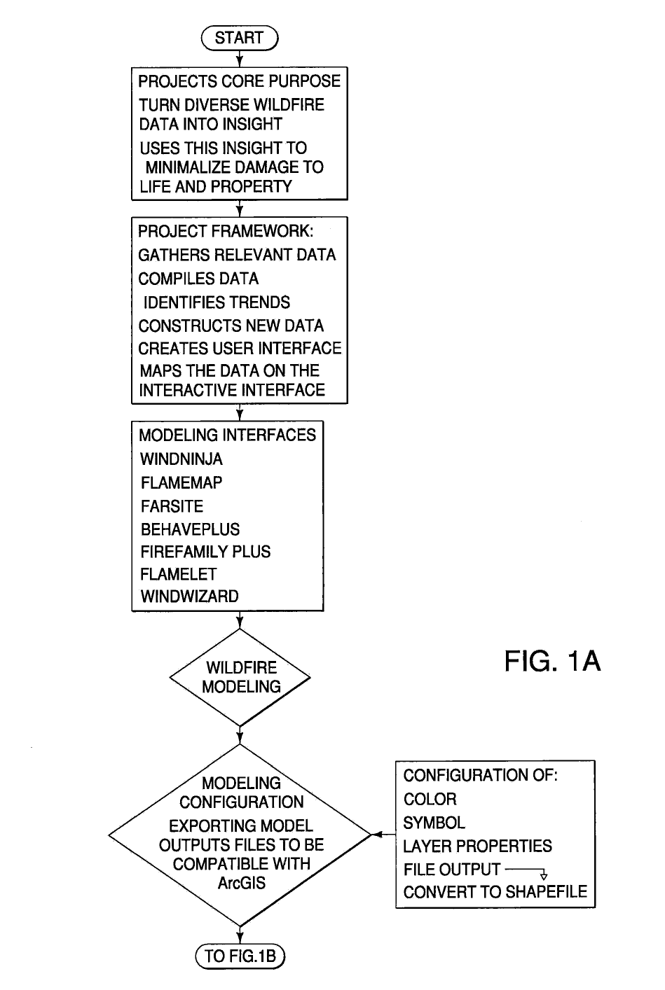

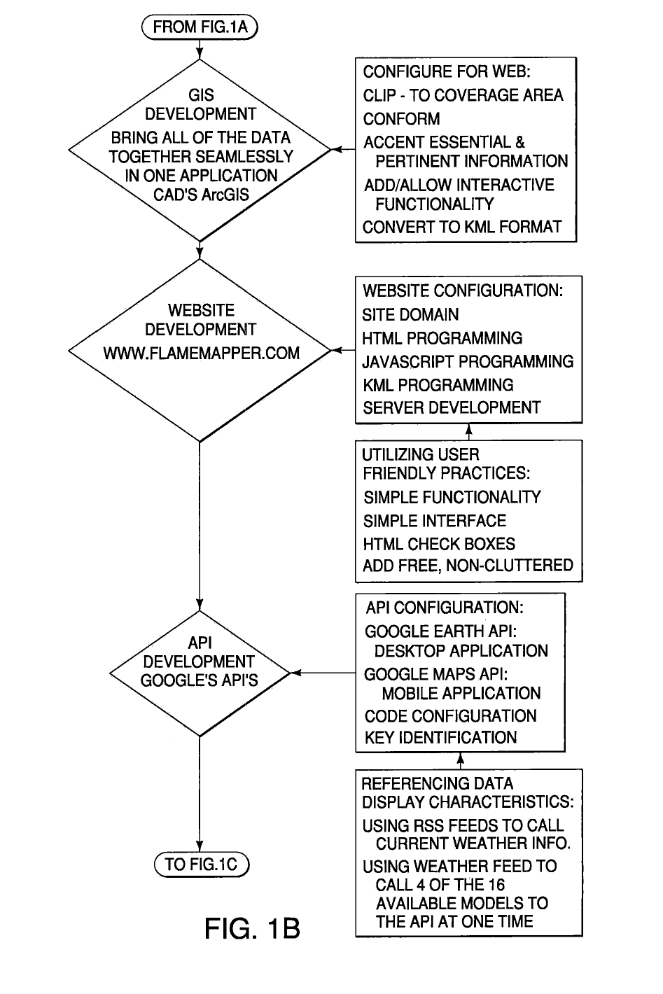

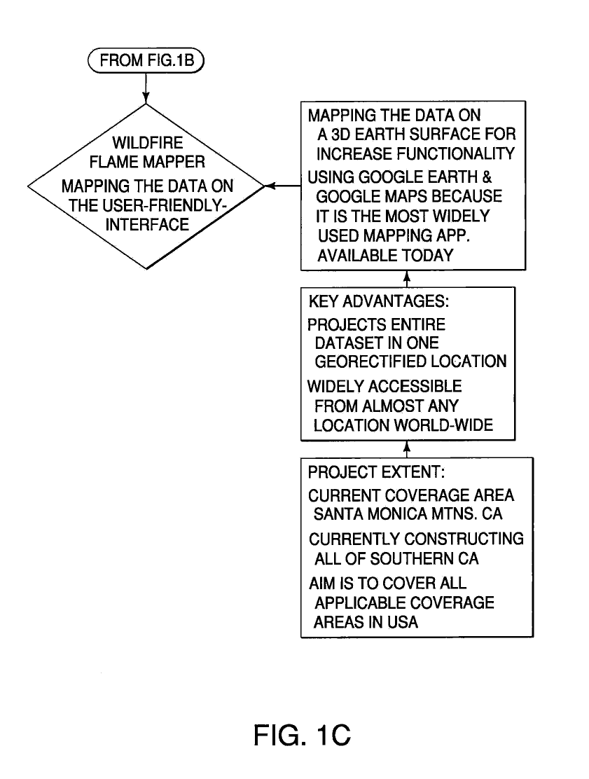

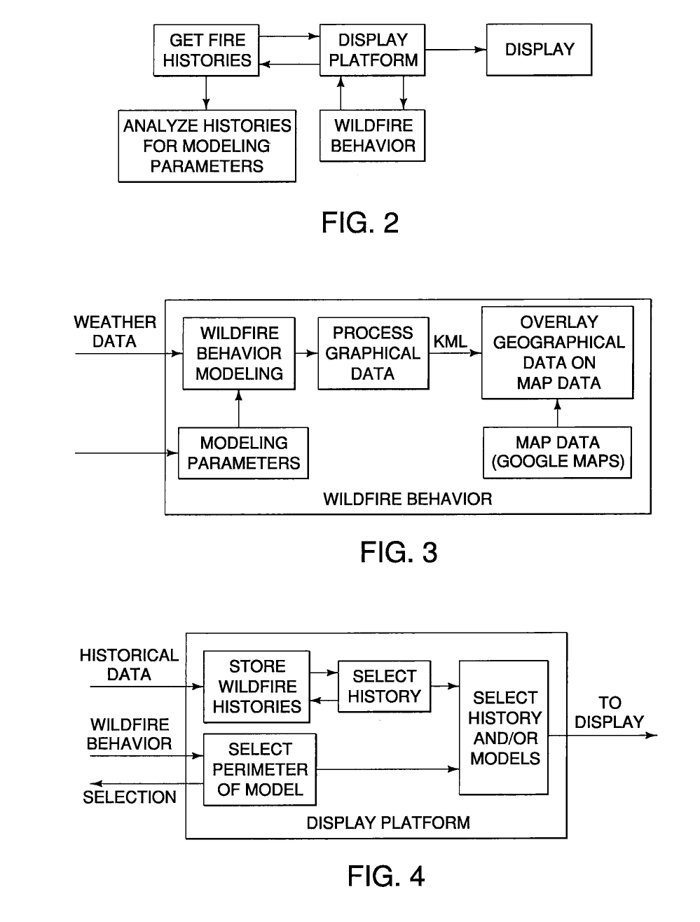

Referring to FIGS. 1, 2, 3 and 4, shown therein is but one embodiment of the method of the present invention. As shown in FIGS. 1 and 2, the first step in the present invention is the securing of the file histories for a predetermined fire area to be analyzed. By way of example, we shall assume that the predetermined fire area is the Santa Monica Mountains of Southern California. The fire history data can be easily secured from the California State Database On Fire History and from other databases such as the California Fire Resource Assessment Program (FRAP). Such data can be easily used individually or combined or layered by loading them into a wildfire simulation program such as ArcMap to create individual fire histories and/or accumulated fire histories for a preselected time period (i.e. a decade) for the predetermined fire area for the 20th century.

The data can then be selected by attributes and divided into data layer groups by decade and interactive functionality can be added to the database by utilizing Visual Basic For Applications Script in ArcMap. This interactive functionality allows the fire history to be selected by a mouse click using a visual or graphical interface on a display of a smartphone, desktop computer, laptop, tablet computer, netbook, notebook, etc. and once a wildfire is selected, a visual preconfigured attribute table can be displayed of the pertinent information relative to the selected wildfire.

By displaying the pertinent information related to a selected wildfire, a user can easily identify the fire safety zones, locate and map water resources for air support and identify suitable locations to drop or place hand crews based upon the fire history data.

In addition to the above, the wildfire history data can be analyzed to determine the significant parameters of wildfires, such as wind speed and direction, fuel type, fuel moisture, humidity levels, elevation, aspect, slope, fuel canopy, canopy height, crown base height, crown bulk density and fuel type. In addition and from this fire history data, preconfigured models can be developed and the behavior of such models can be stored in a memory and analyzed in advance. By way of example an analysis of the wildfire histories in the Santa Monica mountains resulted in that the wind contributes to fires over 1000 acres in one of four ways (1) Santa Anna winds over 30 mile per hour at 30 degrees on a 360 degree compass course, (2) Santa Anna winds over 30 miles an hour at 0 degrees, (3) Santa Anna winds over 30 mile per hour at 1 to 15 degrees or 345 degrees compass course, and winds that do not sustain a given wind direction due to low or mixed wind direction. In addition, it was determined that the relative humidity was most likely less than 10% in almost all case and the terrain and fuel was substantially unchanged. Utilizing this wind information and assumed relative humidity, terrain and fuel, a plurality of preconfigured models are created by doing the calculations in advanced. In this example, four separate models are generated for each of the wind speed and wind direction. These four models are created for the most significant modeling features, namely rate of spread, flame length and major fire paths.

After the preconfigured models are created in the wildfire modeling programs such as FlameMap, the data is then converted and exported to a program for processing geographical such as ArcMap. The output of the program for processing geographical data is then outputted in a compatible file form, such as KML, and overlaid onto geographical map data which is secured from a mapping source such as Google Earth. It should be apparent that both 2D map and topographical map data can be utilized. For speed of operation and security, the geographical data which has been processed is stored in a memory associated with a processor or server and the geographical map data from a source such as Google Earth is further stored in the memory.

The wildfire models and the wildfire histories are stored in the memory and through a visual or graphical interface a user can select a particular model and/or history to be displayed on the display. Also, by means of the graphical or visual interface, weather data such as wind speed and direction can be manually or automatically entered form a source such as an internet website to further predict the movement of the wildfire and or select the appropriate historical data

While the above embodiment has been described as being integrated into a single unit, it should be apparent that for ease of transport, efficiency and speed, the method of the present invention could be performed utilizing the internet or a server and memory of a cloud environment. In other words, the display and graphical interface for making the selection of the desired history and/or models can be provided in a single unit, such as a smartphone, to be used by the user and the remainder of the system and method could be provided at a processor and an associated memory a at remote location accessed via the internet and/or in a cloud environment. In any case, it should be apparent that the large data storage and high speed processors would be most efficiently provided or accessed via the internet or the cloud environment so as to maintain the speed and efficiency of the system and method. Still further, the system could be accessed through the internet or in the cloud environment utilizing an Application Programming Interface (API) which utilizes a username and password. Accordingly, a user using a smartphone as the display and graphical interface could using a simple application (APP) which allows the smartphone to operate as a terminal, access the API and view the fire histories and/or wildfire models. Still further an additional advantage could be achieved utilizing a cloud environment in that the processing could be divided into several tasks such as rate of spread, flame length and major fire paths and the processing be done utilizing a plurality of servers and memories.

An example of software which can be used as part of the present invention is set forth in Source Code as part of this application.

It should be apparent to those skilled in the art that the above described embodiment represents but one of the many possible specific embodiments which could be created utilizing the principles and objects of the present invention.

I Claim:

1. A method for easily displaying wildfire movement and history comprising:
Getting wildfire history data for a predetermined fire area;
Analyzing the wildfire fire history data to find the significant parameters of the wildfires in the predetermined fire area;
Determining wildfire modeling parameters utilizing the significant parameters;
Modeling wildfire behavior based upon the wildfire modeling parameters to create preconfigured models of the predetermined fire area;
Creating geographical data for each of the preconfigured models;
Getting map data for the predetermined fire area;
Overlaying the geographical data onto the map data for the predetermined fire area for each of the preconfigured fire models; and
Selectively displaying overlaid geographic data on the map data on a display.
